(19) United States
(12) Patent Application Publication
(10) Pub. No.: US 2011/0047265 A1
(43) Pub. Date: Feb. 24, 2011

(54) Computer Implemented Method for Identifying Risk Levels for Minors

(75) Inventors: Timothy A. Withers, Chico, CA (US); Leonard W. Fisk, Chico, CA (US); Jeffrey L. Rinek, Rescue, CA (US); Christopher J. Hopkins, Auburn, CA (US)

Correspondence Address: CRAIG PLEDGER, 131 NW 34TH STREET, GAINESVILLE, FL, 32607, US

(73) Assignee: PARENTAL OPTIONS, Rescue, CA (US)

(21) Appl. No.: 12/860,868

(22) Filed: Aug. 21, 2010

Related U.S. Application Data
(60) Provisional application No. 61/236,140, filed on Aug. 23, 2009.

(51) Int. Cl. G06F 15/16; G06F 17/30

(52) U.S. Cl. 709/224; 707/705; 707/802; 707/E17.012

(57) ABSTRACT

A computer system is configured to monitor and analyze the use of a client device by a minor and compute a risk for that minor. Examples of client devices include personal computers, laptops, cellular phones, “smart phones”, and other personal electronic devices. The analysis includes receiving text blocks from the client, processing the text block to discover “hit strings”, compute risk scores for the hit strings, and then to compute an overall risk score for the minor. A hit string is a string of characters such as a word or phrase that is indicative of a risk to the minor such as depression, “cyber bullying”, or an “adult predator”.

### RELATED APPLICATIONS

This non-provisional patent application claims priority to U.S. Provisional Application Ser. No. 61/236,140, Entitled “Computer Implemented Method for Identifying Risk Levels for Minors”, filed on Aug. 23, 2010, incorporated herein by reference under the benefit of U.S.C. 119(e).

### FIELD OF THE INVENTION

The present invention concerns a system configured to help parents or guardians in protecting minors from various threats. More particularly, the present invention concerns a way of analyzing a minor's usage of a system and computing an overall risk level based upon the usage.

### BACKGROUND

Minors have always faced threats to their safety and well being including internal and external threats. Internal threats include accidents, depression/suicide, and self-inflicted harm. External threats include abductions, assaults, and sexual offenders. With the advent of the internet and other societal changes, many of these threats appear to be getting more numerous.

For example, “internet predators” or adults that try to seduce minors using the internet have become widespread. Some of these predators are very sophisticated and hard to detect or identify. In many households, unsupervised children use the internet and are exposed to these criminals.

Along with these threats some minors, particularly teenagers, experience severe depression. This can cause a minor to be more susceptible to the approach of predators or to attempted suicide or acts of violence. These problems can be exacerbated by the actions of “cyber bullies” who use the internet to generally threaten, degrade, and/or destroy the morale of others using the internet.

Generally speaking, parents of minors do their best to interact with and train minors in a way that minimizes the threats and teaches them to avoid them. Unfortunately, in some households with single parents or with both parents employed, sufficient time to monitor and interact with minors may be lacking. What is needed is a way to help even preoccupied parents protect minors from external and internal threats.

### BRIEF DESCRIPTION OF THE FIGURES

FIG. 1 depicts system 10 according to the present invention.

FIG. 2 depicts system 10 according to the present invention including the modules 100-600 within server(s) 20.

FIG. 3 depicts client monitor 100 and its interaction with child system 40 and scan server 200.

FIG. 4A depicts scan server 200 and its interaction with client monitor 100 and alert message server 300.

FIG. 4B depicts fields of a single record 212 that includes character string 218.

FIG. 4C depicts the substrings 218a and delimiters 218b that separate the substrings of character string 218.

FIG. 4D depicts a single record of a “hit table” that is assembled by module 230.

FIG. 5 depicts alert message server 300 and its interaction with scan server 200 and parent system(s) 60.

FIG. 6 depicts dashboard server 400 and its interaction with parent system 60.

### DETAILED DESCRIPTION OF THE PREFERRED EMBODIMENTS

The description refers to “minors” and “children”, and such terms refer to humans that are less than 18 (eighteen) years of age. As such, the terms “minors” and “children” are interchangeable in the context of the present invention. Also, the terms “parents” and “guardians” are used to refer to adults responsible for minors whom they may have in their care and hence will be interchangeable in the context of the present invention.

The present invention applies to “sexual offenders”, “internet predators”, “preferential sex offenders”, and “sexual predators”. In general, these are all adults that pose a substantial risk to minors and often utilize the internet to victimize minors. The present invention applies a means to identify communications between such adults and minors.

The description applies to “cyberbullies”. These may be adults or children who use the internet to threaten, demoralize, or degrade minors. The present invention also provides a means to identify the activities of cyberbullies.

The present invention also applies to protecting children from other threats such as the potential risks of depression or from other children that may pose a threat. The present invention applies to all threats for which the service and/or system of the present invention may be beneficial.

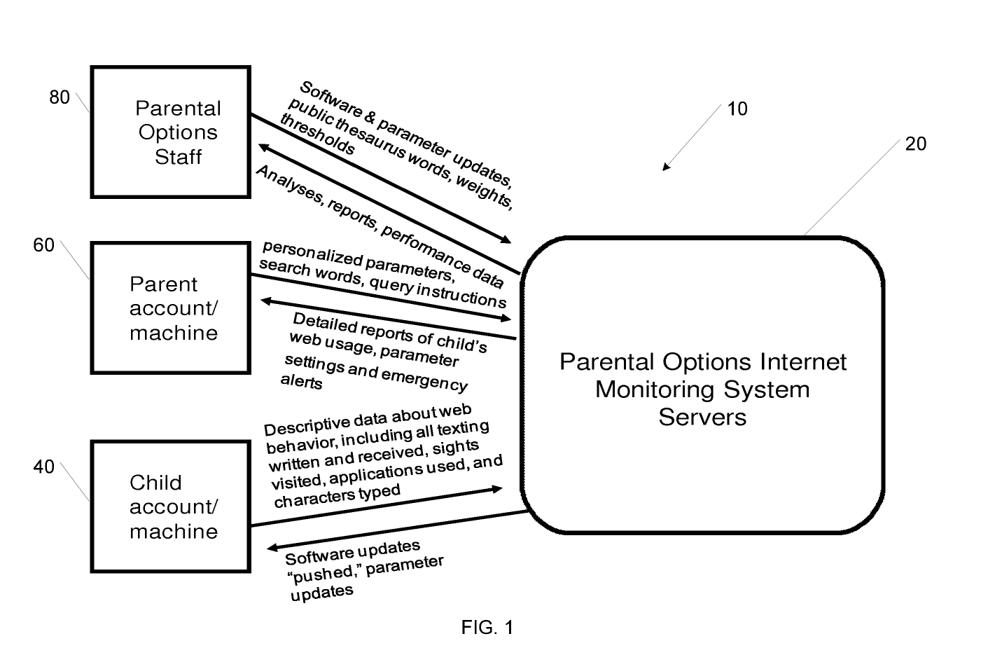

A system 10 according to the present invention is depicted in FIG. 1. This system 10 includes a combination of hardware and software modules configured to protect a minor from the aforementioned threats. System 10 includes server 20 that is coupled via a network (not shown) such as the internet to minor system 40, parent system 60, and staff system 80.

Child system 40 may include a personal computer, a cellular phone, a “smart” phone, a PDA (personal digital assistant), a laptop computer, a portable computer, a tablet, or any other type of client device. Child system 40 will have an associated account for a particular minor or minors. A portion of system 10 may include a software module installed on child system 40 configured to provide information to server 20 that is indicative of the child's use of system 40 for a given account. Such information may include keystrokes, websites visited (including URLS), applications used, and text messages. The information may also include correlations such as keystrokes associated with a particular application or website.

Parent system 60 may include personal computer, a cellular phone, a “smart” phone, a PDA (personal digital assistant), a laptop computer, a portable computer, or any other type of client device. A portion of system 10 may include a software module installed on parent system 60 that is configured to help customize the operation of server system 20 with respect to child system 40 and to receive reports, graphic displays and alerts from server 20 concerning the usage of child system 40.

Staff system 80 may include personal computer, a cellular phone, a “smart” phone, a PDA (personal digital assistant), a laptop computer, a portable computer, or any other type of client device. A portion of system 10 may include a software module installed on staff system 80. Staff system 80 is configured and utilized for the operation, update and maintenance of server 20. Staff system 80 is also configured to receive reports, analysis, and performance data from server 20.

Server 20 is a computer server or equivalent computer system. Server 20 is configured to provide software and parameter updates to child system 40 to assure that the best information is being obtained from child system 40. Server 20 is configured to provide alerts and status reports to parent system 60 concerning the usage of child system 40. Server 20 may be a single computer or a group of computers. Functions within server 20 may be performed by a single computer or be distributed among a number of computers. Server 20 may also exist across multiple redundant parallel processing computers. The redundant computers may be collocated in one facility or may be geographically distributed to reduce a risk of server 20 ceasing to function as a result of facility damage, loss, or malfunction.

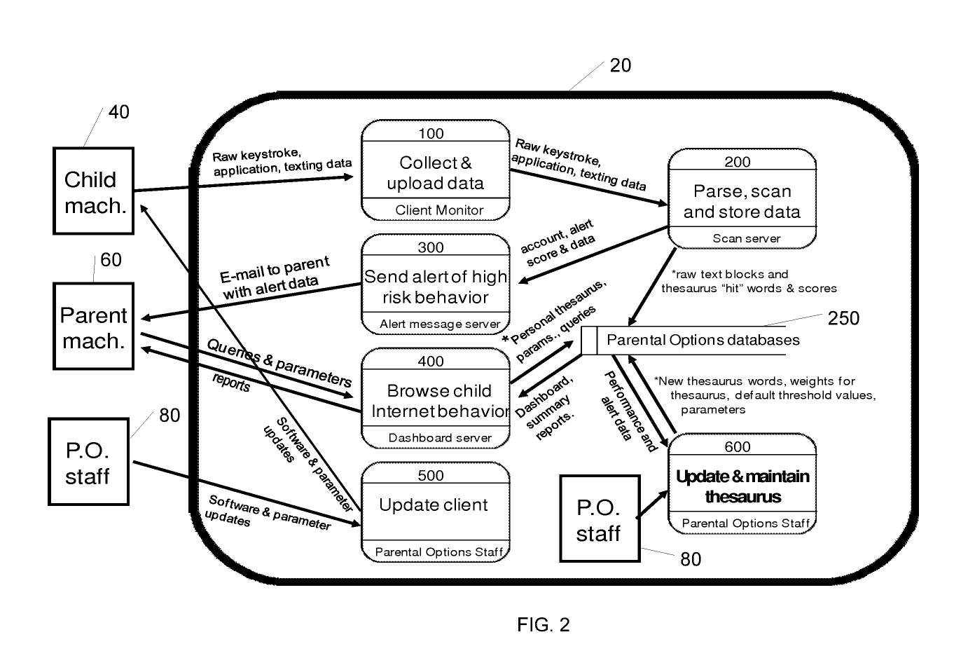

Server system 20 is depicted in greater detail with respect to FIG. 2. Server 20 includes client monitor 100, scan server 200, alert message server 300, dashboard server 400, update server 500, and staff server 600. Each of elements 100, 200, 300, 400, 500, and 600 may be separate computers or may be software modules within one computer server 200. The entire server system 200 may also be mirrored at various sites.

Client monitor 100 is configured to collect and upload data from child system 40 and to pass that data to scan server 200. Scan server 200 is configured to pass the data to database 250. Scan server 200 is also configured to parse and/or analyze the data and pass the data along with results of the analysis to alert server 300 and to database 250. Alert server 300 is configured to send alerts to parent system 60 when the analysis indicates a risk level that exceeds a certain threshold. Dashboard server 400 is configured to provide an interface between parent system 60 and database 250 to allow the parent to view computer generated reports concerning usage of system 40 and to set parameters that concern the monitoring and reporting of results from child system 40. Module 500 is configured to receive inputs from staff system 80 and to update software that is installed on child system 40. Module 600 enables staff system 80 to maintain and update a “thesaurus” that is central to the analysis performed by scan server 200. Database 250 is configured to store data that correlates certain character strings and substrings with scores that are indicative of a risk to a minor.

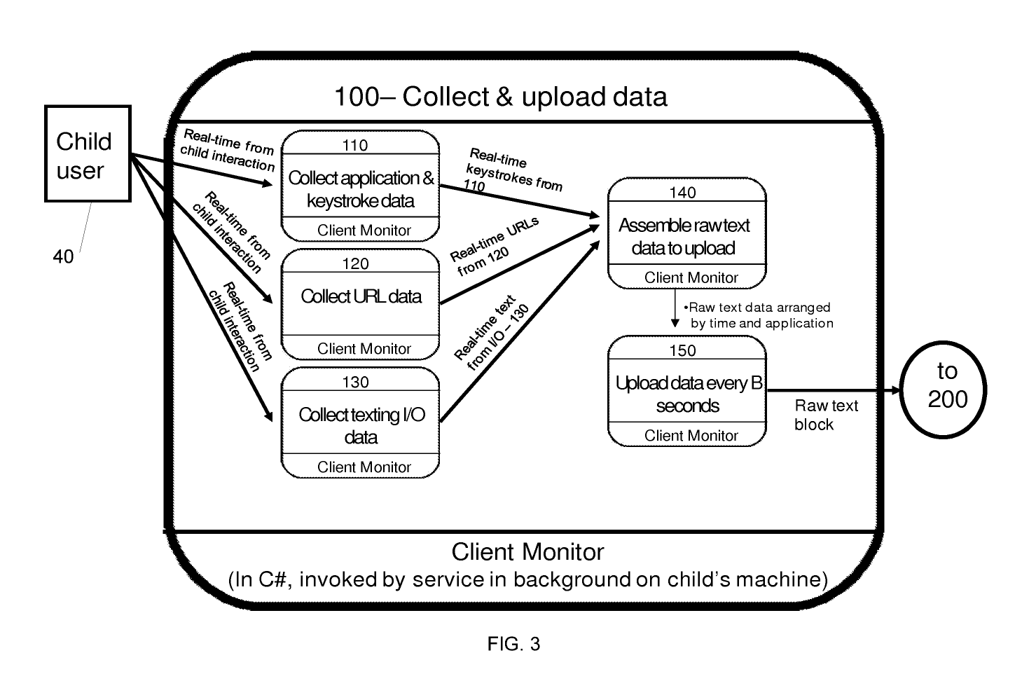

FIG. 3 depicts client monitor 100 in greater detail which includes modules 110-150. Module 110 is configured to collect correlated application and keystroke data from child system 40 in real time. By real time, we mean that module 110 is receiving the data at the same time the child is inputting the data. Also, module 110 passes the data to module 140 in real time. The keystroke and application data is correlated so that text blocks can be associated with applications in later analysis.

Module 120 is configured to collect data that is indicative of web site visitations (URL data) by system 40 and to pass the data to module 140 in real time. Module 130 is configured to collect texting data in real time and to pass the data to module 140 in real time. It is anticipated that other modules may be part of client monitor 100 for collecting other kinds of data.

Module 140 is configured to receive and assemble the data from modules 110-130 for upload. Module 150 is configured to upload the data from module 150 to scan server 200. In one embodiment, uploading occurs with a certain periodicity—module 150 uploads the data to server 200 every B seconds wherein B is an optimized time period.

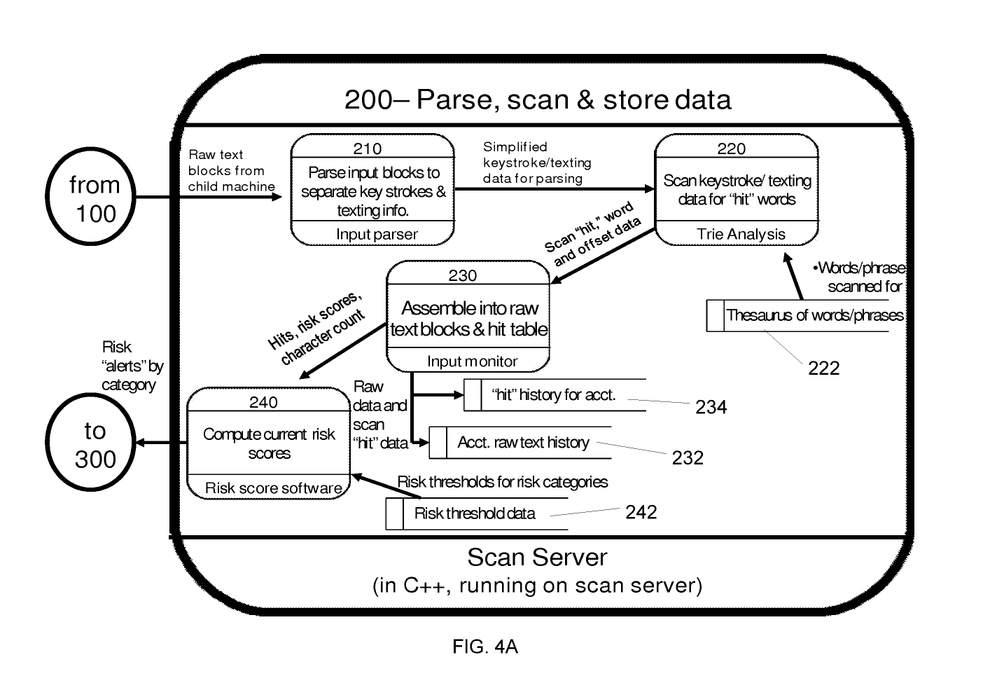

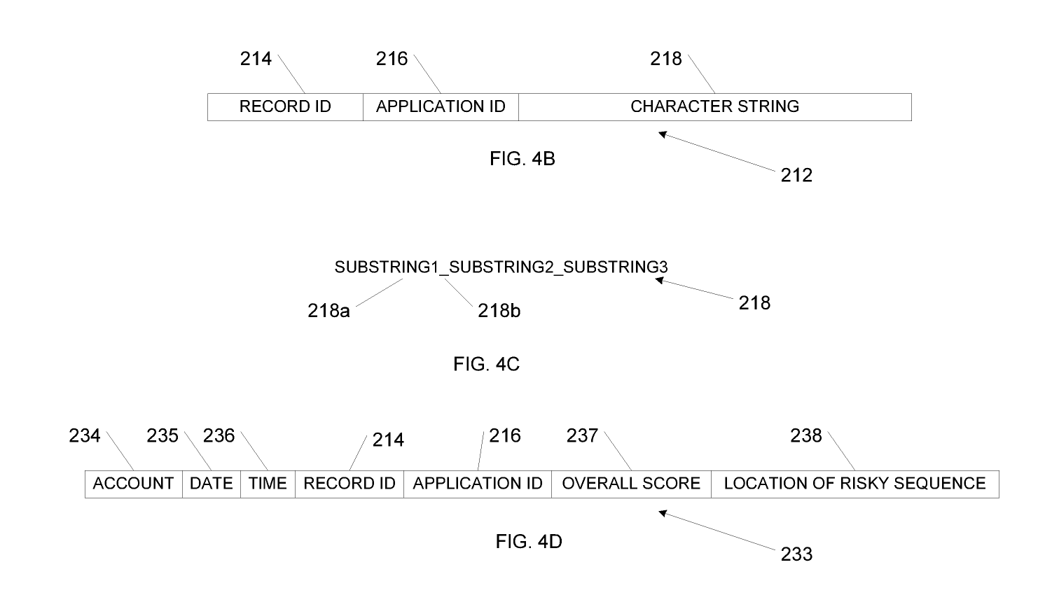

FIG. 4A depicts scan server 200 in greater detail which includes modules 210 to 240. Module 210 is configured to receive a plurality of text blocks from client monitor every B seconds. As a note, text blocks can include text, numerals, spaces, and special characters. In response, module 210 will create a new record 212 for each text block received as depicted in FIG. 4B. Each record 212 will include a first field 214 identifying the text block with information such as a record number.

Each record 212 will include a second field 216 containing information indicative of the application used when the text block was created. Each record 212 will contain a third field 218 that contains a character string 218 that represents the text block. In an exemplary embodiment, module 210 is configured to create the character string 218 by collapsing all upper and lower case letters to lower case and to replace special characters, blanks, and punctuation characters with a standard “delimiter” character. Numerals remain the same, resulting in a total of up to 37 unique characters in the string.

As an example of a character string, consider the incoming text block: “The cat ate 200 rats.” Module 210 would process this text block into the character string “the_cat_ate_{—}200_rats_”. The lower case letters and numbers in this text block remain the same. Upper case letter T is converted to lower case letter t. Spaces between the words and the period are converted to the delimiter character _. Note that the delimiter character can be any character and does not need to be an underscore as is shown herein by example. All special characters such as *, %, $, #, etc., are converted to the delimiter character. Note that there are many variants to processing of text blocks to character strings and that this describes one illustrative example.

Other variations within the scope of the invention are possible, such as the use of additional characters to depict capital letters and special characters. Also, additional records not depicted in FIG. 4B are possible within the inventive scope such as those depicting graphics, picture files, video files, and other information that can be received from child system 40.

FIG. 4C depicts a character string 218 (representing a text block) as a series of substrings 218a separated by delimiters 218b. In the example above, the word “cat” would be a single substring 218a that is preceded and followed by a delimiter 218b.

Module 220 is configured to discover “hit” strings within each character string and to quantify a risk score associated with each hit string. A hit string is defined as a string of characters (sometimes including delimiters) within a text block that has a zero or positive risk score. In the illustrative example a negative risk score is indicative of no risk and is not used in risk computations. A zero risk score indicates a risk of unknown value. A positive risk score indicates a quantified risk and the larger the positive number, the higher the indicated risk.

A correlation of character sequences and risk scores is stored in a thesaurus 222 that is within one of the databases 250. Each correlation may be a record including a field defining the character sequence and a field with the appropriate risk score.

Risk scores are computed by analyzing the character string 218. However, in the forgoing discussion risk scores will be referred to for character strings 218, substrings 218a, words, representations of words, pairs of words, phrases, acronyms, numbers, and combinations thereof. A word is defined as a literal word such as “cat” or a slang word that can typically be found in a standard dictionary. A phrase is a combination of two or more words used as part of a sentence. A phrase includes at least one delimiter separating the two or more words. An acronym is a combination of letters, numbers, or letters and numbers that represent a sentence or phrase. For example, the substring “aitr” may be used to represent “adult in the room” and would likely have a positive risk score. The number string “121” may represent the phrase “one to one”.

Using the information in thesaurus 222, module 220 is configured to identify “hit strings” that include words, pairs of words, phrases, numbers, acronyms, and combinations thereof. This is a significant advantage over systems that only look for risky words. For example, a hit string may contain a combination of words that are not individually hit words. To give an example, the text string “touch_you” is formed with two substrings that may not be hit substrings and yet the combination may be a hit string. As another example a substring like “fondle” would likely be a hit substring. On the other hand, a typist might try to disguise the word by creating a text string such as “fon*dle”. The two substrings fon and dle may not be hit substrings but the combination can be even when separated by a delimiter.

As stated earlier, each character string 218 is a sequence of characters that include lower case letters, numbers, and delimiters and is a result of module 210 acting upon an incoming text block. Each character string 218 is processed by module 220 using a “trie” search algorithm. Each character will be compared to a character contained in a “node” in a “trie” tree. The “trie” tree is constructed using data from the thesaurus 222. Module 220 usually starts a new trie search after each delimiter although some character sequences having risk scores may include delimiters within them (in the case of pairs of substrings as shown in the examples above). Module 220 processes the nodes sequentially, keeping a risk score as the hit strings are identified using the thesaurus 222. The result from module 220 will be one or more of the hit strings and a risk score associated with each (assuming that any are discovered by module 220).

Module 230 is configured to assemble the results from module 220 into “raw text blocks” and “hit table” entries for each text block. The “raw text block” is the original block of text received from the client before it was converted into a character string 218 to support the search. Each raw text block is stored according to 232.

The “hit table” is a set of records for “hit” character strings within the character strings 218 having zero or nonzero risk scores. Any particular character string 218 may have multiple hit strings within it, and each of these will result in a separate hit string record 233. One such record is depicted in FIG. 4D.

Each hit string record 233 will include the account 234 (on the child system 40), date 235, time 236, and record ID 214 of the text block (represented by character string 218). An application ID 216 is indicative of the application being used on the child system 40 when the text string was generated. Each record will also include a risk score 237 for the hit string and information 238 indicative of where the hit string is located within the character string 218 such as fields including the start location and end location of the hit character string.

Module 240 is configured to compute a running overall risk score for every N input text blocks received. In one embodiment this overall risk score may be equal to the sum of the risk scores per 1000 characters of the N text blocks. According to 242 a threshold risk score is defined based on inputs from parent system 60. Module 240 is configured to issue alert information to alert message server 300 if and when a running overall risk score exceeds the threshold risk score.

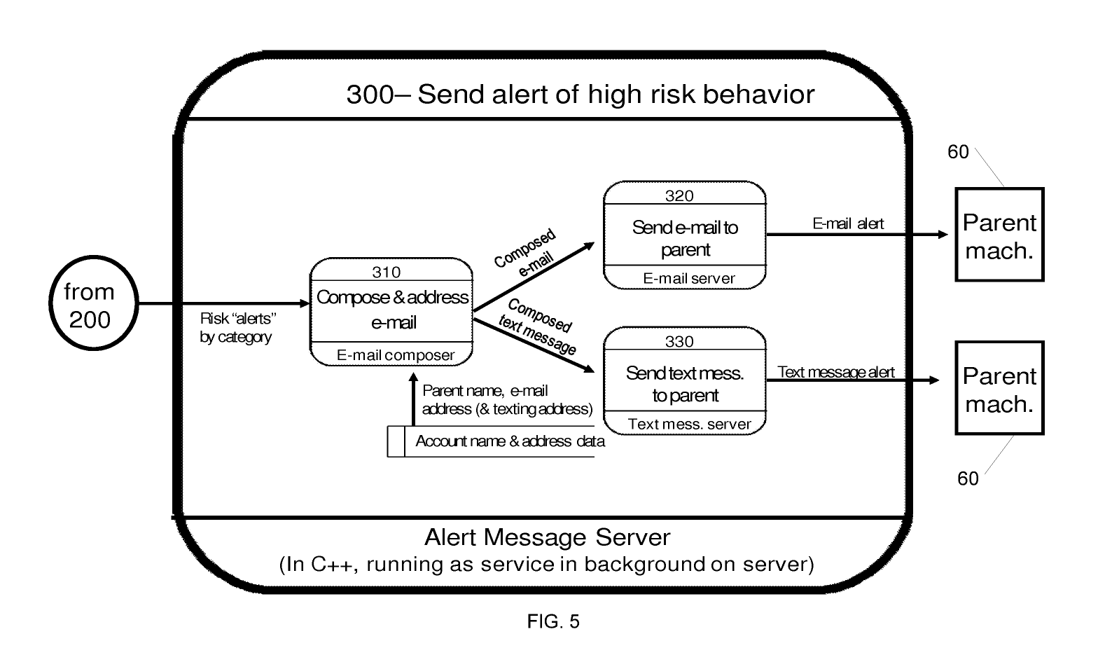

FIG. 5 depicts alert message server 300 having modules 310 to 330. Module 310 is configured to compose and address a message to be sent to a parent system 60 in response to receiving information from server 200 that is indicative of a running overall risk score exceeding a risk threshold for a given account. Module 320 is configured to deliver the message as an e-mail (electronic mail) to parent system 60. Module 330 is configured to deliver the message as a text message to another parent system 60. In one embodiment, the parent machine 60 is a cellular or smart phone configured to receive a text message from module 330. Alert message server 300 may contain other modules (not shown) that use other formats for delivering message such as voice, graphical, or video formats to name a few. For example, alert message server may include a module to send an alert to a parent cellular phone in voice format.

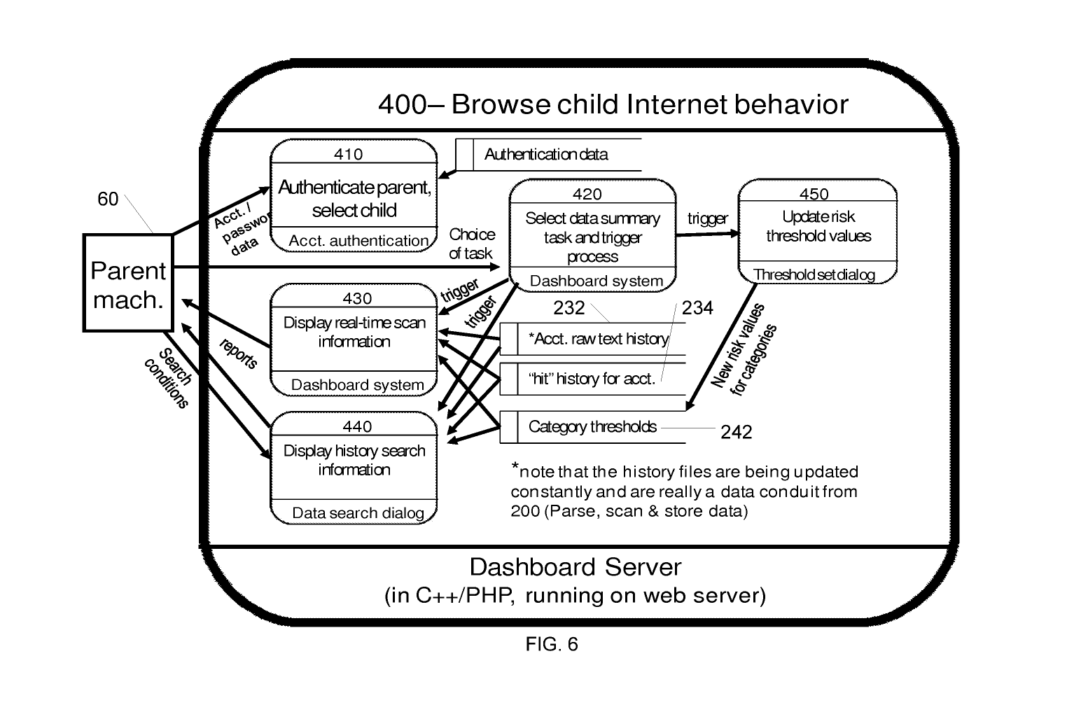

FIG. 6 depicts a dashboard server 400 that includes modules 410-450. Dashboard server 400 is configured to provide a summaries for each child account that is associated with a parent account. Module 410 is configured to provide a login mechanism so that a parent using system 60 can view information associated with a selected child account.

Module 420 is configured to receive commands or settings from parent system 60 that affect how server 20 responds to data received from a child account 40. For example, some settings may set a risk score threshold that determines what overall risk score causes module 240 to generate an alert to be sent to a parent or guardian. Other settings may indicate certain key words that are particularly risky for a given child. Thus, module 420 allows a parent to customize a risk profile and risk computations for a given child account. Risk threshold values 242 are updated using module 450.

Module 430 is configured to display real time risk results on parent system 60 based on the selected child account based upon receiving raw text history 232, “hit” history 234, and risk thresholds 242. The results of this module would tend to correlate with the alerts sent by alert message server 300.

Module 440 is configured to display historical results and trends on parent system 60 based upon inputs from module 420, raw text history 232, “hit” history 234, and risk thresholds 242.

1. A computer implemented method for determining a risk level to a minor utilizing a client computer comprising:
receiving a text block from an account on the client computer;
processing the text block to discover a plurality of hit strings and a risk score associated with each hit string; and
computing an overall risk level for the text block based upon the risk scores.

2. The computer implemented method of claim 1 wherein processing the text block includes converting the text block into a character string.

3. The computer implemented method of claim 1 wherein processing the text block includes the use of a trie tree and algorithm.

4. The computer implemented method of claim 1 further comprising accessing a database containing records correlating hit strings to risk scores.

5. The computer implemented method of claim 4 wherein some hit strings in the database represent individual words.

6. The computer implemented method of claim 4 wherein some hit strings in the database represent a plurality of two or more individual words.

7. The computer implemented method of claim 4 wherein some hit strings in the database represent acronyms.

8. The computer implemented method of claim 1 wherein the text block is a plurality of text blocks.

9. The computer implemented method of claim 1 wherein computing the overall risk level includes a normalization relative to the number of characters in the text block.

10. The computer implemented method of claim 1 wherein the overall risk level is based upon a sum of the risk scores.

11. The computer implemented method of claim 1 further comprising sending an alert to a person responsible for the minor when the overall risk level is above a risk threshold.

12. A computer system for determining a risk level to a minor comprising:
a client monitor configured to capture a text block from a client operated by the minor;
an analytical system configured to:
process the text block to discover a plurality of hit strings and a risk score associated with each hit string; and
compute an overall risk level for the text block based upon the risk scores.

13. The computer system of claim 12 further comprising a database storing records each containing a hit string and a risk score.

14. The computer system of claim 13 wherein some hit strings represent individual words.

15. The computer system of claim 13 wherein some of the hit strings represent combinations of two or more words that are not individually hit words.

16. The computer system of claim 12 wherein the analytical system is configured to compare the overall risk level with a threshold risk level and to send an alert to a person responsible for the minor when the overall risk level meets or exceeds the threshold risk level.

17. A computer program product stored on a computer readable medium that when executed by a computer system is configured to:
receive a text block from a client computer;
process the text block to discover a plurality of hit strings and a risk score associated with each hit string; and
compute an overall risk level for the text block utilizing the risk scores.

18. The media of claim 17 wherein the computer program product is configured to identify hit strings that represent two or more words.

19. The media of claim 17 wherein the computer program product is configured to identify hit strings that represent acronyms that are combinations of letters representing combinations of words.

20. The media of claim 17 wherein the computer program product is configured to:
process the text block to define a character string wherein each string includes a plurality of character substrings that are joined by delimiters;
discover hit strings from among individual substrings; and
discover hit strings from among phrases wherein each phrase is a combination of substrings.
